(19) United States
(12) Patent Application Publication
(10) Pub. No.: US 2022/0327819 A1
(43) Pub. Date: Oct. 13, 2022

(54) IMAGE PROCESSING APPARATUS, IMAGE PROCESSING METHOD, AND PROGRAM

(71) Applicant: Socionext Inc., Kanagawa (JP)

(72) Inventor: Soichi HAGIWARA, Yokohama (JP)

(21) Appl. No.: 17/847,932

(22) Filed: Jun. 23, 2022

Related U.S. Application Data
(63) Continuation of application No. PCT/JP2019/051584, filed on Dec. 27, 2019.

(51) Int. Cl. G06V 10/98; G06V 20/56

(52) U.S. Cl. CPC G06V 10/993; G06V 20/56

(57) ABSTRACT

An image processing apparatus includes a processor, and a memory storing instructions that, when executed by the processor, perform operations including determining an image quality of an image, from which an object outside of a moving body is detected, based on a situation about movement of the moving body, and outputting the image at the determined image quality.

### CROSS-REFERENCE TO RELATED APPLICATION

The present application is a continuation application filed under 35 U.S.C. 111 (a) claiming benefit under 35 U.S.C. 120 and 365 (c) of PCT International Application No. PCT/JP2019/051584 filed on Dec. 27, 2019 and designating the U.S., the entire contents of which are incorporated herein by reference.

### FIELD

The present disclosure relates to an image processing apparatus, an image processing method, and a program.

### BACKGROUND

There is a conventional technique for detecting objects in front of a moving body by using images (frames) acquired at respective points in time from a camera provided in a moving body such as a vehicle.

### SUMMARY

An image processing apparatus according to the present disclosure includes a processor and a memory storing instructions that, when executed by the processor, perform operations including determining an image quality of an image, from which an object outside of a moving body is detected, based on a situation about movement of the moving body, and outputting the image at the determined image quality.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a block diagram of image-capturing apparatuses provided on a moving body according to an embodiment.

FIG. 2 is a block diagram of an example of the moving body according to the embodiment.

FIG. 3 is a block diagram of a hardware configuration example of an image processing apparatus and a control apparatus according to an embodiment.

FIG. 4 is a block diagram of an example of the image processing apparatus and the control apparatus according to the embodiment.

FIG. 5 is a flowchart illustrating an example of processing of a server according to an embodiment.

FIG. 6 is a table of an example of training data according to an embodiment.

FIG. 7 is a flowchart illustrating an example of processing performed by the image processing apparatus and the control apparatus according to the embodiment.

### DESCRIPTION OF EMBODIMENTS

For example, Japanese Laid-Open Patent Publication No. 2017-139631 discloses a conventional technique for detecting objects in front of a moving body by using images (frames) acquired at respective points in time from a camera provided in a moving body such as a vehicle.

However, with the conventional technique, it is desired to improve the detection of objects depending on the moving condition of the moving body, the surrounding environment of the moving body, and the like. Accordingly, it is desired to provide a technique capable of more appropriately detecting objects.

Hereinafter, an embodiment of the present disclosure is explained with reference to drawings.

<Entire Configuration>

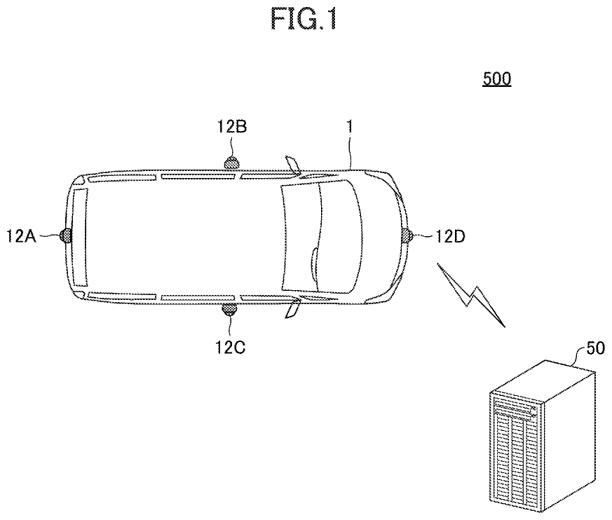

FIG. 1 is a block diagram of a control system 500 according to an embodiment. In the example of FIG. 1, the control system 500 includes a moving body 1 and a server 50. The number of moving bodies 1 and the number of servers 50 are not limited to the numbers illustrated in the example of FIG. 1.

For example, the moving body 1 and the server 50 communicate via a network such as: a mobile phone network such as 5G (5th Generation Mobile Communication System), 4G, LTE (Long Term Evolution), 3G, and the like; wireless local area network (WLAN); the Internet; and the like.

The moving body 1 is, for example, a moving machine such as a vehicle travelling on land with wheels, a robot moving with legs, aircraft, unmanned aerial vehicle (drone), and the like. Examples of vehicles include an automobile, a motorcycle, a robot moving with wheels, a railroad car travelling on railways, and the like. Examples of automobiles include an automobile travelling on a road, a streetcar, a construction vehicle used for the purpose of construction, a military vehicle for military, an industrial vehicle for transporting cargo, an agricultural vehicle, and the like.

For example, the server 50 performs machine learning on the basis of images captured by the moving body 1 and generates a trained model for recognizing an object. In addition, the server 50 distributes the generated trained model to the moving body 1.

«Example of Arrangement of Image-Capturing Apparatus»

FIG. 1 illustrates the moving body 1, i.e., an automobile, as seen from immediately above. In the example of FIG. 1, the moving body 1 includes an image-capturing apparatus 12A, an image-capturing apparatus 12B, an image-capturing apparatus 12C, and an image-capturing apparatus 12D (hereinafter collectively referred to as “image-capturing apparatuses 12” when it is not necessary to distinguish them from one another).

The image-capturing apparatuses 12 are apparatuses for capturing images. The image-capturing apparatuses 12 are, for example, cameras.

The image-capturing apparatus 12A is an image-capturing apparatus (a rear camera or a rearview camera) that captures images on the rear side as seen from the moving body 1 (in the direction opposite to the traveling direction in normal circumstances). The image-capturing apparatus 12B is an image-capturing apparatus (a left camera) that captures images on the left side as seen from the moving body 1. The image-capturing apparatus 12C is an image-capturing apparatus (a right camera) that captures images on the right side as seen from the moving body 1. The image-capturing apparatus 12D is an image-capturing apparatus (a front camera) that captures images on the front side as seen from the moving body 1 (in the traveling direction in normal circumstances).

The image-capturing apparatus 12A, the image-capturing apparatus 12B, the image-capturing apparatus 12C, and the image-capturing apparatus 12D may be, for example, an advanced driver-assistance system (ADAS) for supporting driving operations of the driver or an image-capturing apparatus for capturing images for automatic driving. Furthermore, the image-capturing apparatus 12A, the image-capturing apparatus 12B, the image-capturing apparatus 12C, and the image-capturing apparatus 12D may be, for example, cameras for capturing images for an all-around view (panoramic view, multi-view, or top view) for generating an image as seen from immediately above the moving body 1.

The image-capturing apparatus 12A may be, for example, a camera for capturing an image that is to be displayed on a rearview monitor. Alternatively, the image-capturing apparatus 12A may be, for example, a camera for capturing an image that is to be displayed on a screen of a navigation apparatus 18 when the moving body 1 moves in reverse (backs up).

The image-capturing apparatus 12B may be, for example, a camera for capturing an image that is to be displayed on a side-view monitor for the left side. The image-capturing apparatus 12C may be, for example, a camera for capturing an image that is to be displayed on a side-view monitor for the right side.

The image-capturing apparatus 12D for capturing images on the front side as seen from the moving body 1 (in the traveling direction in normal circumstances) may be a stereo camera including multiple cameras.

<Moving Body 1>

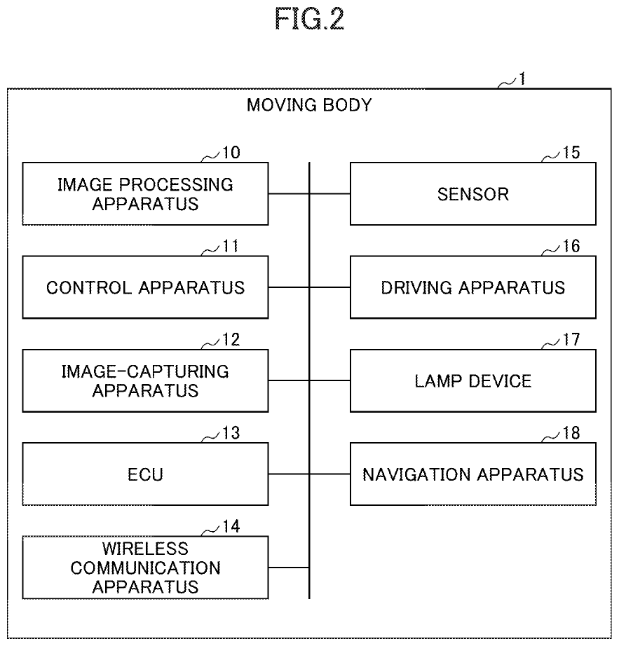

FIG. 2 is a block diagram of an example of the moving body 1 according to the embodiment. In the example of FIG. 2, the moving body 1 includes an image processing apparatus 10, a control apparatus 11, an image-capturing apparatus 12, an electronic control unit (ECU) 13, a wireless communication apparatus 14, a sensor 15, a driving apparatus 16, a lamp device 17, and a navigation apparatus 18.

These units are connected by, for example, an internal network (for example, a vehicle network) such as a controller area network (CAN), Ethernet (registered trademark), and the like.

The image processing apparatus 10 generates an image from which the control apparatus 11 detects objects outside of (around) the moving body 1, on the basis of images (still pictures and moving pictures) captured by the image-capturing apparatus 12. Examples of objects include other vehicles, pedestrians, bicycles, road surface markings such as traffic lanes, sidewalls of roads, obstacles, and the like.

The control apparatus 11 is a computer (an information processing apparatus) controlling each unit of the moving body 1. The control apparatus 11 recognizes objects outside of the moving body 1, on the basis of images generated by the image processing apparatus 10. In addition, the control apparatus 11 tracks the recognized object on the basis of images generated at respective points in time by the image processing apparatus 10. The control apparatus 11 controls movement or the like of the moving body 1 by controlling the ECU 13 or the like of the moving body 1 on the basis of the detected object (i.e., the recognized object and the tracked object).

For example, the control apparatus 11 may control movement or the like of the moving body 1 to achieve automatic driving in any level from level zero at which the driver (i.e., a user or an occupant) operates the main control system (acceleration, steering, braking, and the like) to level 5 at which unmanned driving is performed.

The ECU 13 is an apparatus for controlling the units of the moving body 1. The ECU 13 may include multiple ECUs. The wireless communication apparatus 14 communicates with an apparatus outside of the moving body 1, such as the server 50 and a server on the Internet, by, for example, wireless communication with a mobile phone network or the like.

The sensor 15 is a sensor for detecting various kinds of information. The sensor 15 may include, for example, a position sensor for acquiring current position information of the moving body 1. The position sensor may be, for example, a sensor using a satellite positioning system such as a global positioning system (GPS).

Also, the sensor 15 may include a speed sensor for detecting the speed of the moving body 1. The speed sensor may be, for example, a sensor for detecting the rotational speed of the axle of the wheels. The sensor 15 may include an acceleration sensor for detecting the acceleration of the moving body 1. The sensor 15 may include a yaw-axis angle speed sensor for detecting the yaw-axis angle speed (yaw rate) of the moving body 1.

Furthermore, the sensor 15 may include an operation sensor for detecting the amount of operation or the like of the moving body 1 by the driver and the control apparatus 11. The operation sensor may include, for example, an acceleration sensor for detecting the amount of depression of the acceleration pedal, a steering sensor for detecting the angle of rotation of the steering wheel, a brake sensor for detecting the amount of depression of the brake pedal, a gear shifter position sensor for detecting the position of the gear shifter, and the like.

The driving apparatus 16 is an apparatus for moving the moving body 1. The driving apparatus 16 may include, for example, an engine, a steering apparatus, a braking apparatus, and the like.

The lamp device 17 is a lighting device provided in the moving body 1. The lamp device 17 may include, for example, headlamps (headlights), lamps of turn signals (blinkers) for indicating the direction of right and left turns or lane change, reverse lights (backup lights) that are provided at the rear of the moving body 1 and that are turned on when the gear shifter is at the reverse position, brake lamps, and the like.

The navigation apparatus 18 is an apparatus (a car navigation system) that guides the driver to the destination either by audio or visual means. The navigation apparatus 18 may store map information. Furthermore, the navigation apparatus 18 may transmit information about the current position of the moving body 1 to an external server providing the car navigation service, and may obtain map information around the moving body 1 from the external server. The map information may include, for example, information about nodes indicating intersections, links (roads) between nodes, and the like.

<Hardware Configuration of Computer>

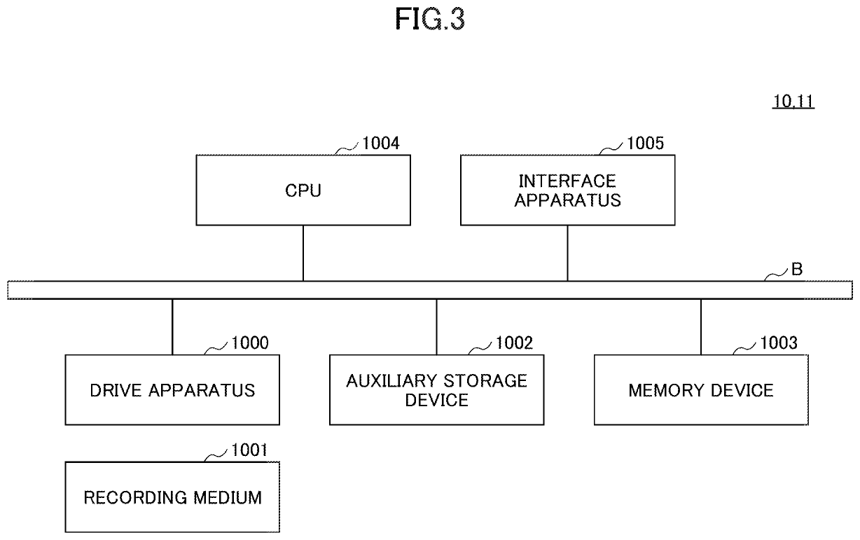

FIG. 3 is a block diagram of a hardware configuration example of the image processing apparatus 10 and the control apparatus 11 according to the embodiment. Hereinafter, the image processing apparatus 10 is explained as an example. The hardware configuration of the control apparatus 11 may be substantially the same as the hardware configuration of the image processing apparatus 10.

In the example of FIG. 3, the image processing apparatus 10 includes a drive apparatus 1000, an auxiliary storage device 1002, a memory device 1003, a CPU 1004, an interface apparatus 1005, and the like, which are connected to one another via a bus B.

The information processing program that achieves the processing on the image processing apparatus 10 is provided by a recording medium 1001. When the recording medium 1001 storing the information processing program is set in the drive apparatus 1000, the CPU 1004 installs the information processing program from the recording medium 1001 via the drive apparatus 1000 to the auxiliary storage device 1002. However, the information processing program does not have to be necessarily installed from the recording medium 1001. The information processing program may be downloaded via the network from another computer. The auxiliary storage device 1002 stores not only the installed information processing program but also required files, data, and the like.

In a case where an instruction to start the program is given, the CPU 1004 reads the program from the auxiliary storage device 1002 to the memory device 1003. The CPU 1004 executes processing according to the program stored in the memory device 1003. The interface apparatus 1005 is used as an interface for connecting to the network.

For example, the recording medium 1001 may be a portable recording medium such as a CD-ROM, a Digital Versatile Disc (DVD), or a USB memory, or the like. The auxiliary storage device 1002 may be, for example, a hard disk drive (HDD), a flash memory, or the like. The recording medium 1001 and the auxiliary storage device 1002 are an example of a computer-readable recording medium.

The image processing apparatus 10 may be implemented by, for example, an integrated circuit such as an application specific integrated circuit (ASIC) or a field-programmable gate array (FPGA).

<Image Processing apparatus 10 and Control Apparatus 11>

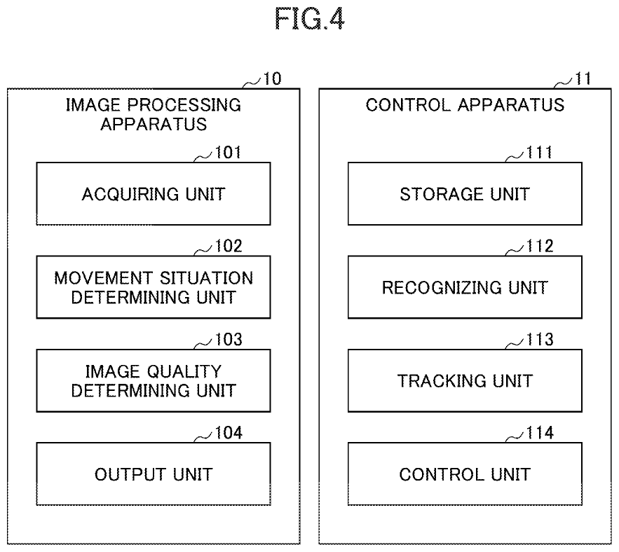

Next, the image processing apparatus 10 and the control apparatus 11 are explained with reference to FIG. 4. FIG. 4 is a block diagram of an example of the image processing apparatus 10 and the control apparatus 11 according to the embodiment.

«Image Processing Apparatus 10»

The image processing apparatus 10 includes an acquiring unit 101, a movement situation determining unit 102, an image quality determining unit 103, and an output unit 104. These units may be implemented by causing hardware such as the CPU 1004 of the image processing apparatus 10 to execute one or more programs installed in the image processing apparatus 10.

The acquiring unit 101 acquires data from another apparatus. The acquiring unit 101 acquires, for example, images captured by the image-capturing apparatus 12 from the image-capturing apparatus 12. Furthermore, for example, the acquiring unit 101 acquires various kinds of information from various units of the moving body 1 via the ECU 13 and the like. Furthermore, the acquiring unit 101 acquires, for example, information from the apparatus outside of the moving body 1 via the wireless communication apparatus 14 or the like.

The movement situation determining unit 102 determines the situation about movement of the moving body 1 on the basis of information acquired by the acquiring unit 101.

The image quality determining unit 103 determines the image quality of the image, from which an object outside of the moving body 1 is detected, on the basis of the situation about movement of the moving body 1 determined by the movement situation determining unit 102.

The output unit 104 outputs an image of the image quality determined by the image quality determining unit 103 to the control apparatus 11.

«Control Apparatus 11»

The control apparatus 11 includes a storage unit 111, a recognizing unit 112, a tracking unit 113, and a control unit 114. These units may be implemented by causing hardware such as the CPU of the control apparatus 11 to execute one or more programs installed in the control apparatus 11.

The storage unit 111 stores a trained model distributed by the server 50.

On the basis of, e.g., the trained model stored in the storage unit 111 and the image that is output from the image processing apparatus 10, the recognizing unit 112 recognizes an object included in the image. For example, the recognizing unit 112 may recognize the type of the object, a relative position (distance) with reference to the moving body 1, and the like. For example, the recognizing unit 112 may classify, as the type of the object, a vehicle, a motorcycle, a bicycle, a person, others, and the like.

The tracking unit 113 tracks the object recognized by the recognizing unit 112, on the basis of images that are output at respective points in time from the image processing apparatus 10, over the respective points in time.

The control unit 114 controls the moving body 1 on the basis of the distance between the moving body 1 and each object tracked by the tracking unit 113.

<Processing>

«Learning Phase»

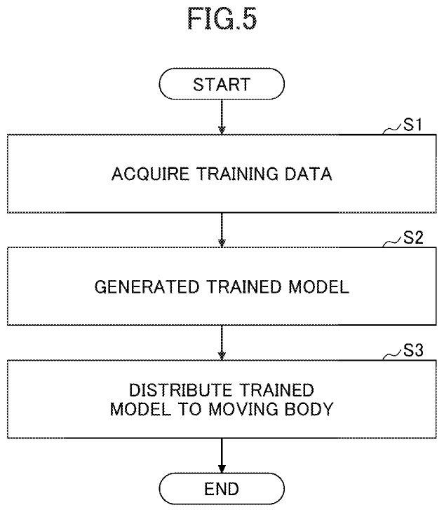

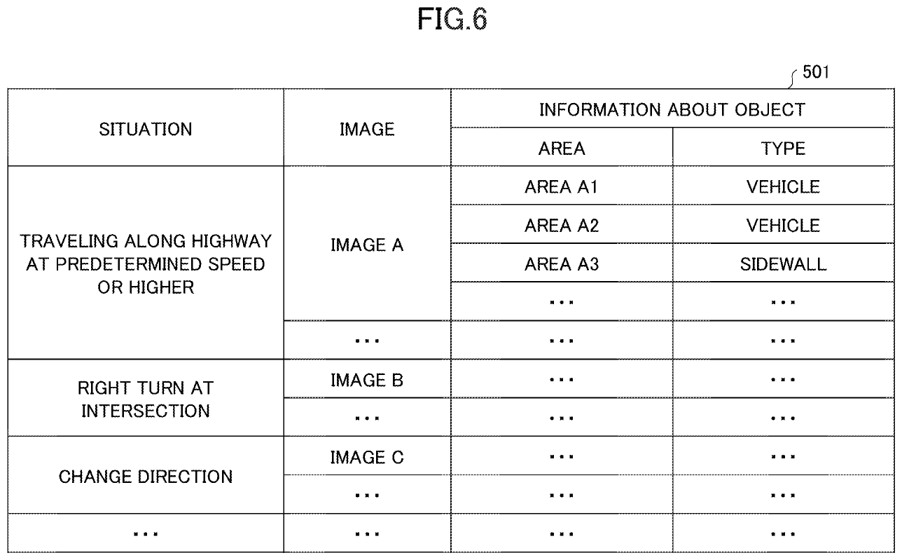

Next, processing of the server 50 is explained with reference to FIG. 5. FIG. 5 is a flowchart illustrating an example of processing of the server 50 according to the embodiment. FIG. 6 is a table of an example of training data 501 according to the embodiment.

In step S1, the server 50 acquires the training data 501 of supervised training. In the example of FIG. 6, the training data 501 includes: a situation (scene) about movement of the moving body 1, an image of the image-capturing apparatus 12, and multiple sets (datasets) of information about objects in the image. The information about objects in the image includes information indicating an area of an object in the image and a type (label) of the object. The information indicating an area of an object may be, for example, upper left coordinates and lower right coordinates of a rectangular area where the object is located in the image. The type of an object may include, for example, a vehicle, a motorcycle, a bicycle, a person, others, and the like.

The training data 501 may be generated on the basis of, for example, an image for data collection generated when the moving body 1 travels. Information about an object in the image included in the training data 501 may be labeled by, for example, as correct data by an engineer or the like of a company that develops the moving body 1.

Also, the situation about movement of the moving body 1 included in the training data 501 may be labeled by, for example, as correct data by an engineer or the like of a company that develops the moving body 1, or may be automatically labeled by the image processing apparatus 10 or the like.

Next, the server 50 performs machine learning based on the training data 501, and generates a trained model (step S2). In this case, for example, the server 50 may perform machine learning by deep learning or the like. In this case, for example, for each situation about movement of the moving body 1, the server 50 may perform machine learning by convolutional neural network (CNN). Therefore, for example, in a case where the moving body 1 is driving on a highway, the speed of the recognition processing can be increased by generating a trained model for classification into a vehicle, a motorcycle, a sidewall, others, and the like. Also, in a case where the moving body 1 is traveling through a shopping arcade, the recognition target can be classified into more detailed types by generating a trained model for classification into a vehicle, a motorcycle, a bicycle, an elderly person, an adult, a child, others, and the like.

The server 50 may perform machine learning based on the training data 501 on the basis of transfer learning to generate a trained model. In this case, the server 50 may perform, based on the training data 501, retraining of the CNN trained with respect to various types of objects on the basis of images other than the images of the image-capturing apparatus 12 of the moving body 1.

The server 50 may improve the recognition accuracy by additionally using other classifiers using the situation about movement of the moving body 1. In this case, for example, the server 50 may generate a trained model with which other classifiers using the situation about movement of the moving body 1 classify features (CNN features) calculated with the CNN. In this case, the server 50 may use, as other classifiers, for example, support vector machine (SVM) and the like. Accordingly, for example, likelihood of being a given type (probability of being a given type) can be inferred according to the situation, and therefore, an image of a certain object can be recognized as a bicycle when the moving body 1 is travelling through a shopping arcade, and the same image can be recognized as a motorcycle when the moving body 1 is travelling through a highway.

Next, the server 50 distributes the trained model to the moving body 1 (step S3). Accordingly, the storage unit 111 of the control apparatus 11 of the moving body 1 stores the trained model. The server 50 may distribute a trained model to the moving body 1 to cause the moving body 1 to store the trained model according to the situation around the moving body 1 as necessary. The moving body 1 may store a trained model generated by the server 50 to the storage unit 111 in advance. The moving body 1 may store multiple trained models generated by the server 50 to the storage unit 111 in advance, and may select any one of the multiple trained models according to the situation around the moving body 1.

«Inference Phase»

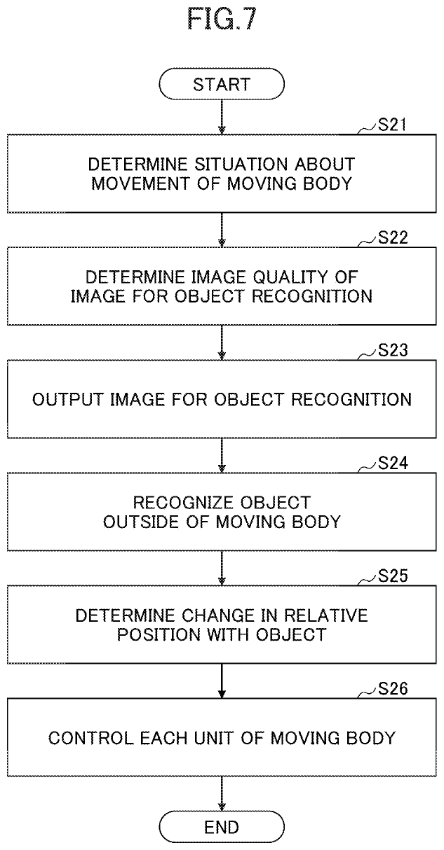

Next, processing of the image processing apparatus 10 and control apparatus 11 of the moving body 1 is explained with reference to FIG. 7. FIG. 7 is a flowchart illustrating an example of processing performed by the image processing apparatus 10 and the control apparatus 11 according to the embodiment.

In step S21, the movement situation determining unit 102 of the image processing apparatus 10 determines the situation about movement of the moving body 1. In this case, the image processing apparatus 10 may determine the situation about movement of the moving body 1 on the basis of information acquired via the image-capturing apparatus 12, the ECU 13, the wireless communication apparatus 14, or the like.

For example, the image processing apparatus 10 may determine the situation of the road on which the moving body 1 is currently traveling and the situation of an object outside of the moving body 1 on the basis of the images captured by the image-capturing apparatus 12. In this case, for example, the image processing apparatus 10 may determine the width of the road on which the moving body 1 is currently traveling, the degree of visibility, whether there is a sidewall of a highway or the like, whether there is a vehicle parked on the shoulder of a road, traffic situation of roads, and the like, on the basis of a still picture (one frame) captured by the image-capturing apparatus 12. For example, the image processing apparatus 10 may determine an approaching speed of a vehicle behind the moving body 1 with reference to the moving body 1, on the basis of moving pictures (multiple frames) captured by the image-capturing apparatus 12.

Furthermore, the image processing apparatus 10 may determine the situation about movement of the moving body 1 on the basis of information acquired from each unit of the moving body 1 via the ECU 13 and the like. In this case, for example, the image processing apparatus 10 may determine attributes of the road on which the moving body 1 is currently traveling and attributes of the road on which the moving body 1 will travel at respective points in time within a predetermined period of time in the future (for example, one minute) from the present time, on the basis of information acquired from the navigation apparatus 18. In this case, for example, the attributes of the road may include information indicating the type of a road such as a highway, an ordinary road (a national road), a major local road, a prefectural road, a municipal road, and a private road. In addition, for example, the attributes of the road may include information about the number of lanes, the width of a road, the position of attributes of a link (a bridge, a viaduct, a tunnel, a cave, a railroad crossing, a pedestrian bridge, a tollhouse, an underpass, expected road flooding points, and the like). For example, the image processing apparatus 10 determines the traffic jam situation on the road on which the moving body 1 is currently traveling, on the basis of information acquired from the navigation apparatus 18.

For example, the image processing apparatus 10 may determine the situation about movement of the moving body 1 on the basis of the current speed, the acceleration, the steering angle of steering operation, the acceleration (acceleration pedal) operation, the brake (brake pedal) operation (deceleration operation), lighting of turn signals (blinkers), and lighting of headlamps (headlights) of the moving body 1. In this case, the image processing apparatus 10 may acquire from the ECU or the like information about driver's operations or information about operation (automatic driving control) performed with the control apparatus 11.

For example, the image processing apparatus 10 may determine the situation about movement of the moving body 1 on the basis of information acquired from a vehicle information and communication system (VICS, registered trademark), a cloud service, or the like.

In this case, for example, the image processing apparatus 10 may determine whether the road on which the moving body 1 is currently traveling and the road on which the moving body 1 will travel at respective points in time within a predetermined period of time in the future (for example, one minute) from the present time includes a point where a traffic accident frequently occurs or a point where a traffic jam frequently occurs, or may determine the weather or the like of the position where the moving body 1 is currently traveling.

Subsequently, the image quality determining unit 103 of the image processing apparatus 10 may determine the image quality of an image (an image for object recognition), from which an object outside of the moving body 1 is detected, on the basis of the situation about movement of the moving body 1 (step S22).

(Example of Low Resolution and Low Frame Rate)

For example, in a case where the situation around the moving body 1 does not change greatly over time, and there are a small number of recognition target objects, the image processing apparatus 10 may determine an image quality of a low resolution and a low frame rate (for example, 30 fps). The image processing apparatus 10 may determine, as the low resolution, a resolution of QVGA (Quarter Video Graphics Array, 320×240 pixels), VGA (Video Graphics Array, 640×480 pixels), or the like.

In this case, for example, in a case where the moving body 1 is parked in a parking lot or is driven to be parked, the image processing apparatus 10 may determine a low resolution and a low frame rate. For example, in a case where the current position of the moving body 1 acquired from the navigation apparatus 18 is a parking lot and is not a road, the image processing apparatus 10 may determine that the moving body 1 is situated in a parking lot. For example, in a case where the speed of the moving body 1 is determined to be equal to or less than a threshold value (for example, 5 km/hour), and the gear shifter is detected as being at the reverse position, the image processing apparatus 10 may determine that the moving body 1 is driven to be parked, and accordingly determine an image quality of a low resolution and a low frame rate.

For example, in a case where the moving body 1 is traveling in a traffic jam section at a low speed, the image processing apparatus 10 may determine a low resolution and a low frame rate. For example, the image processing apparatus 10 may determine that the moving body 1 is traveling in a traffic jam section on the basis of traffic jam information about the current position of the moving body 1 acquired from the navigation apparatus 18. For example, in a case where it is recognized from an image captured by the image-capturing apparatus 12 that many vehicles are gathering ahead, the image processing apparatus 10 may determine that the moving body 1 is traveling in a traffic jam section.

(Example of Low Resolution and High Frame Rate)

For example, in a case where the situation around the moving body 1 changes greatly over time, and there are a small number of recognition target objects, the image processing apparatus 10 may determine an image quality of a low resolution and a high frame rate (for example, 60 fps or 120 fps).

In this case, for example, in a case where the moving body 1 is traveling along a highway at a predetermined speed or higher, the image processing apparatus 10 may determine a low resolution and a high frame rate. This is because, for example, pedestrians, bicycles, and the like, i.e., targets to be recognized at a high resolution, are not present on highways, and accordingly, it is considered that a low resolution is sufficient. On the other hand, on highways, the tracking accuracy of objects is relatively important in order to, e.g., avoid collision by predicting a future relative position between the moving body 1 and an object around the moving body 1 that cuts into the lane or approaches rapidly from behind, and therefore, it is considered that tracking processing in an image is performed at a high frame rate.

For example, in a case where the current position of the moving body 1 acquired from the navigation apparatus 18 is a highway, the image processing apparatus 10 may determine that the moving body 1 is traveling on a highway. For example, in a case where a sidewall of a highway or the like is recognized from an image captured by the image-capturing apparatus 12, the image processing apparatus 10 may determine that the moving body 1 is traveling on a highway. In a case where the speed of the moving body 1 is a predetermined speed (for example, 60 km/hour) or higher, the image processing apparatus 10 may determine that the moving body 1 is traveling along a highway at a predetermined speed or higher.

For example, when the moving body 1 changes the direction, the image processing apparatus 10 may determine a low resolution and a high frame rate. In this case, for example, the image processing apparatus 10 may detect that the moving body 1 changes the direction on the basis of operation of turn signals, steering wheel operation, and the like.

For example, in a case where the speed of the moving body 1 is determined to be equal to or more than a threshold value (for example, 80 km/hour), the image processing apparatus 10 may determine a low resolution and a high frame rate.

For example, the image processing apparatus 10 may increase a frame speed in accordance with an increase in the speed of the moving body 1. This is because, for example, the accuracy in determining the speed of an approaching object is more important than the accuracy in determining what kind of object is approaching to the moving body 1, and accordingly, it is desired to improve the tracking accuracy (tracking performance) of the recognized object.

For example, in a case where the acceleration of the moving body 1 in the traveling direction is equal to or more than a threshold value, the image processing apparatus 10 may determine a low resolution and a high frame rate. This is to, for example, reduce the impact of collision that occurs due to a sudden start of the moving body 1.

For example, in a case where the deceleration of the moving body 1 (i.e., acceleration in a direction opposite to the traveling direction of the moving body 1) is equal to or more than a threshold value, the image processing apparatus 10 may determine a low resolution and a high frame rate. This is to, for example, reduce the risk of a rear-end collision by a vehicle behind due to sudden stop (sudden braking) of the moving body 1.

(Example of High Resolution and Low Frame Rate)

For example, in a case where the situation around the moving body 1 does not change greatly over time, and there are a large number of recognition target objects, the image processing apparatus 10 determines an image quality of a high resolution and a low frame rate. The image processing apparatus 10 may determine, as the high resolution, a resolution of FHD (Full HD, 1920×1080 pixels), 4K (4096×2160 pixels), or the like.

In this case, for example, in a case where the moving body 1 is traveling along a road other than a highway, the image processing apparatus 10 may determine a high resolution and a low frame rate. This is because in a case where the moving body 1 is traveling along a municipal road or a narrow road or through a residential area or shopping arcade (which may be hereinafter referred to as a “municipal road or the like” as appropriate), the accuracy in distinguishing whether an object is a pedestrian, a traveling bicycle, or the like is relatively important in order to, e.g., predict a future relative position between the object and the moving body 1, and accordingly, it is considered that it is desired to perform recognition processing with an image of a high resolution. Furthermore, for example, as compared with the case where the moving body 1 travels along, for example, a highway or the like, the speed of the moving body 1 is lower, and therefore, it is considered that a low frame rate is sufficient.

(Example of High Resolution and High Frame Rate)

For example, in a case where the situation around the moving body 1 changes greatly over time, and there are a large number of recognition target objects, the image processing apparatus 10 may determine an image quality of a high resolution and a high frame rate. Accordingly, for example, in a highly dangerous situation, a high accuracy object detection can be performed.

In this case, for example, in a case where the moving body 1 enters an intersection, the image processing apparatus 10 may determine a high resolution and a high frame rate. For example, in a case where the moving body 1 enters an intersection, there are many targets to be recognized such as oncoming vehicles, pedestrians walking on a crosswalk, traffic lights, a vehicle behind the moving body 1, and the like, and the situation changes rapidly, but when an image of a high resolution and a high frame rate is used, targets to be recognized around the moving body 1 in the intersection can be recognized accurately at a high speed.

For example, in a case where the moving body 1 is traveling along a municipal road or the like at a high speed, the image processing apparatus 10 may determine a high resolution and a high frame rate. In this case, for example, in a case where the current position of the moving body 1 acquired from the navigation apparatus 18 is a municipal road or the like, and the speed of the moving body 1 is determined to be equal to or more than a threshold value (for example, 80 km/hour), the image processing apparatus 10 may determine that the moving body 1 is traveling along a municipal road or the like at a high speed.

(Example of Luminance, Contrast, and Color)

For example, the image processing apparatus 10 may determine an image quality of luminance, contrast, color, and the like of an image on the basis of the situation about movement of the moving body 1. In this case, for example, in a case where the moving body 1 travels at night and travels through a tunnel, the image processing apparatus 10 may correct a change in color of an object due to colors of headlights and tunnel lightings by increasing the luminance and the contrast.

(Example for Determining Image Quality of Image Captured by Multiple Image-Capturing Apparatuses 12)

The image processing apparatus 10 may determine the image quality of an image acquired from each of the multiple image-capturing apparatuses 12 on the basis of the situation about movement of the moving body 1. In this case, for example, in a case where the acceleration of the moving body 1 in a predetermined direction is equal to or more than a threshold value, the image processing apparatus 10 may increase at least one of the resolution and the frame rate of an image captured by a first image-capturing apparatus in the predetermined direction of the moving body 1. The image processing apparatus 10 may decrease at least one of the resolution and the frame rate of an image captured by a second image-capturing apparatus in a direction different from the predetermined direction.

In this case, for example, in a case where the deceleration of the moving body 1 is equal to or more than a threshold value, the image processing apparatus 10 may decrease at least one of the resolution and the frame rate of an image captured by the image-capturing apparatus 12D in the front direction of the moving body 13 and may increase at least one of the resolution and the frame rate of images captured by the image-capturing apparatus 12A, the image-capturing apparatus 12B, and the image-capturing apparatus 12C. Accordingly, for example, in a case where the moving body 1 suddenly stops (suddenly brakes), the recognition accuracy in recognizing a vehicle behind the moving body 1 can be improved.

For example, in a case where the acceleration of the moving body 1 in the traveling direction is equal to or more than a threshold value, the image processing apparatus 10 may decrease at least one of the resolution and the frame rate of an image captured by the image-capturing apparatus 12A in the rear direction of the moving body 1, and may increase at least one of the resolution and the frame rate of an image captured by the image-capturing apparatus 12D and the like. Accordingly, for example, in a case where the moving body 1 rapidly starts, the recognition accuracy in recognizing a vehicle located in front of the moving body 1 can be improved.

Subsequently, the output unit 104 of the image processing apparatus 10 outputs an image for object recognition at the determined image quality (step S23). Accordingly, the processing load of the control apparatus 11 can be reduced.

In this case, the image processing apparatus 10 may generate an image for object recognition from the images captured by the image-capturing apparatus 12.

The image processing apparatus 10 may cause the image-capturing apparatus 12 to capture images at the image quality determined by the image quality determining unit 103. In this case, for example, the image processing apparatus 10 may transmit a control command for setting the image quality to the image-capturing apparatus 12. Then, the image-capturing apparatus 12 may capture an image at the image quality designated by the received control command, and may output the captured image to the image processing apparatus 10 or the control apparatus 11.

The image processing apparatus 10 may cause the control apparatus 11 to recognize an object outside of the moving body 1 on the basis of information about the situation about movement of the moving body 1 and the image at the image quality determined by the image quality determining unit 103. In this case, the image processing apparatus 10 also outputs information about the situation about movement of the moving body 1 determined by the movement situation determining unit 102 to the control apparatus 11. Accordingly, the control apparatus can perform inference that is also based on the situation about movement of the moving body 1, so that the accuracy for recognizing an object is improved. The image processing apparatus 10 may output, to a display apparatus for display for the driver of the moving body 1, an image of the same image quality as the image that is output to the control apparatus 11 or an image of a different image quality from the image that is output to the control apparatus 11. The display apparatus may be, for example, a rearview monitor or a side-view monitor, or may be included in the navigation apparatus 18.

Subsequently, the recognizing unit 112 of the control apparatus 11 recognizes an object outside of the moving body 1 on the basis of an image for object recognition, a trained model stored in the storage unit 111, and the like (step S24). The control apparatus 11 may recognize road surface markings such as traffic lanes by recognition processing without using machine learning.

In this case, the control apparatus 11 may infer an area of an object in the image and the type of an object by using a trained model according to the situation about movement of the moving body 1 explained above in the processing of step S2 of FIG. 5. The control apparatus 11 may infer an area of an object in the image and the type of an object by using other classifiers using the situation about movement of the moving body 1 explained above in the processing of step S2 in FIG. 5.

Subsequently, the tracking unit 113 of the control apparatus 11 determines (tracks) a change in a relative position between the recognized object and the moving body 1 (step S25). Accordingly, the control apparatus 11 can predict a future relative position between the recognized object and the moving body 1.

In this case, for example, the control apparatus 11 may track an object according to the following processing. First, the control apparatus 11 calculates, in the current frame, a predicted position of the object A that is recognized or tracked in the previous frame. In this case, for example, the control apparatus 11 may calculate, in the current frame, the predicted position of the object A on the basis of the speed of the moving body 1, the speed of the tracked object A, and the traveling direction with respect to the moving body 1. Subsequently, in a case where the type of the object A recognized in the previous frame or a frame before the previous frame is the same as the type of the object B recognized in the current frame, and a difference between the predicted position of the object A in the current frame and the position of the object B in the current frame is equal to or less than a threshold value, the control apparatus 11 determines that the object B is the object A, and records the type, the position, and the traveling direction of the object A (the object B).

Subsequently, the control unit 114 of the control apparatus 11 controls each unit of the moving body 1 on the basis of, e.g., a change in a relative position between the recognized object and the moving body 1 (step S26). In this case, for example, the control apparatus 11 may notify the driver of presence of an obstacle, a rapidly approaching vehicle behind, and the like, with a display, a speaker, and the like of the moving body 1. Furthermore, for example, the control apparatus 11 may perform automatic driving of the moving body 1.

### Modified Embodiment

For example, each functional unit of the image processing apparatus 10 and the control apparatus 11 may be achieved by cloud computing provided by one or more computers. The image processing apparatus 10 and the control apparatus 11 may be implemented by a single apparatus. The image processing apparatus 10 and the image-capturing apparatus 12 may be implemented by a single apparatus. The machine learning processing of the server 50 may be configured to be performed by the control apparatus 11. The moving body 1 may have a semiconductor device, and the image processing apparatus 10 and the control apparatus 11 may be included in a single semiconductor device. The moving body 1 may include multiple semiconductor devices, the image processing apparatus 10 may be included in one of the semiconductor devices, and the control apparatus 11 may be included in another of the semiconductor devices.

According to the embodiment and modified embodiment, objects can be detected more appropriately.

The present invention is not limited to the configuration and the like described above. Specifically, additions and changes can be made with respect to embodiments without departing from the subject matter described in the claims, and the embodiments can be appropriately implemented according to the applications form thereof.

Although the present invention has been described above with reference to the embodiments, the present invention is not limited to the features described in the embodiments. These features can be changed without departing from the scope of the claimed subject matter, and can be appropriately determined according to the implementation to which the present invention is applied.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing apparatus comprising:
a processor; and
a memory storing instructions that, when executed by the processor, perform operations including:
determining an image quality of an image, from which an object outside of a moving body is detected, based on a situation about movement of the moving body; and
outputting the image at the determined image quality.

2. The image processing apparatus according to claim 1, wherein the outputting further comprises generating the image at the determined image quality, based on an image captured by an image-capturing apparatus provided on the moving body.

3. The image processing apparatus according to claim 1, wherein the outputting further comprises causing an image-capturing apparatus provided on the moving body to capture the image at the determined image quality.

4. The image processing apparatus according to claim 1, wherein the outputting further comprises causing the object outside of the moving body to be recognized based on information indicating the situation about the movement of the moving body and the image at the determined image quality.

5. The image processing apparatus according to claim 1, wherein the determining further comprises determining at least one of a resolution and a frame rate of the image, from which the object outside of the moving body is detected, based on the situation about the movement of the moving body.

6. The image processing apparatus according to claim 1, wherein the determining further comprises determining at least one of a luminance, a contrast, and a color of the image, from which the object outside of the moving body is detected, based on the situation about the movement of the moving body.

7. The image processing apparatus according to claim 1, wherein the determining further comprises determining the image quality of the image, from which the object outside of the moving body is detected, based on a speed, an acceleration, an angle of steering, an acceleration operation, a deceleration operation, lighting of turn signals, and lighting of headlamps of the moving body. 20

8. The image processing apparatus according to claim 1, wherein the determining further comprises determining the image quality of the image, from which the object outside of the moving body is detected, based on an image captured by an image-capturing apparatus provided on the moving body.

9. The image processing apparatus according to claim 1, wherein the determining further comprises, in response to detecting that an acceleration in a predetermined direction of the moving body is equal to or more than a threshold value, increasing at least one of a resolution and a frame rate of an image captured by a first image-capturing apparatus in the predetermined direction of the moving body and decreasing at least one of a resolution and a frame rate of an image captured by a second image-capturing apparatus in a direction different from the predetermined direction.

10. An image processing method executed by a processor of an image processing apparatus to perform operations comprising:
determining an image quality of an image, from which an object outside of a moving body is detected, based on a situation about movement of the moving body; and
outputting the image at the determined image quality.

11. A non-transitory computer-readable recording medium storing instructions that, when executed by a processor of an image processing apparatus, perform operations comprising:
determining an image quality of an image, from which an object outside of a moving body is detected, based on a situation about movement of the moving body; and
outputting the image at the determined image quality.
